(19) United States
(12) Patent Application Publication
(10) Pub. No.: US 2009/0201938 A1
(43) Pub. Date: Aug. 13, 2009

(54) ACCESS POINT AND METHOD FOR OPERATING THE ACCESS POINT

(75) Inventor: Yoshinobu SATO, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Buffalo Inc., Nagoya-shi (JP)

(21) Appl. No.: 12/366,959

(22) Filed: Feb. 6, 2009

(30) Foreign Application Priority Data
Feb. 8, 2008 (JP) 2008-028380

(51) Int. Cl. H04L 12/56

(52) U.S. Cl. 370/401

(57) ABSTRACT

An access point is connectable to a first network and a second network different from the first network. The access point includes: a communication control device configured to connect one or more first terminals on the first network to the second network; and a communication stop device configured to deactivate at least a part of the communication control device when a condition on a time length or a time is fulfilled, such that at least one target terminal of the one or more first terminals is disconnected from the second network.

### CROSS-REFERENCE TO RELATED APPLICATIONS

This application is based on and claims the priority from Japanese Patent Application No. 2008-028380 filed on Feb. 8, 2008, the entire contents of which are incorporated herein by reference.

### TECHNICAL FIELD

The present invention relates to an access point connectable to a first network and a second network, and a method for operating the access point.

### BACKGROUND

Communication via network has already become widespread. In some of the communication systems, an access point is used for relaying data among terminals to allow a plurality of terminals to communicate one another via networks.

One example of a network is a WAN (Wide Area Network) such as the Internet, and another example of the network is a Local Area Network (LAN) such as a wireless LAN. JP-A-6-252916 describes a wireless LAN device serving as an access point used in a wireless LAN.

The network communication for a home use has been already become prevalent as well as for a business use. In the home use, the range of uses of communication via a network embraces entertainment.

Accordingly, in one mode of use of the access point, the access point is used in the home. Specifically, a terminal used in the home, i.e., a station associated with the access point in the same home, is connected to the Internet via the access point serving as a relay node. Consequently, the station is connectable to another terminal via the Internet which is a terminal that is not associated with the access point.

In such a use, it is desirable that the access point be basically connected to the stations all the time. This is because the user of the station is guaranteed by a fulltime connection to enable access to the Internet at any desired time. Therefore, from a user friendly viewpoint, it is desirable that the access point is connected to the station all the time.

However, limitations on communication between the access point and the station are occasionally required.

A personal computer (PC) having a communication function and a device equipped with a computer having a communication function (e.g., a game machine) have already become popular as a device for enjoying entertainment at home. The user of the device establishes communication with another terminal via the Internet for pleasure.

In recent years, a game machine having a communication function is quickly, increasingly becoming popular in ordinary households. Therefore, the population of children enjoying entertainment by use of the Internet is rapidly increasing.

In the meantime, in the household, parents obliged to manage their children generally desire to control a time period during which the children play games by accessing the Internet.

However, the related-art access point does not have any function of stopping communication with its station at the initiative of the access point, therefore, cannot control the time of usage of the Internet.

### SUMMARY

The present invention was made in consideration of the above circumstances, and an object thereof is to provide an access point that performs a function of relaying communication between a station and a terminal that is not associated with the access point via a network and a method for operating the access point, wherein the access point can control a time for allowing a connection from the station to the network.

According to a first aspect of the invention, there is provided an access point connectable to a first network and a second network different from the first network, said access point comprising: a communication control device configured to connect one or more first terminals on the first network to the second network; and a communication stop device configured to deactivate at least a part of the communication control device when a condition on a time length or a time is fulfilled, such that at least one target terminal of the one or more first terminals is disconnected from the second network.

According to a second aspect of the invention, there is provided a method for operating an access point that comprises a communication control device configured to connect one or more first terminals on a first network to the second network different from the first network, said method comprising: connecting the one or more first terminals to the second network; and deactivating at least a part of the communication control device when a condition on a time length or a time is fulfilled, such that at least one target terminal of the one or more first terminals is disconnected from the second network.

According to a third aspect of the invention, there is provided a computer readable medium having a computer program stored thereon and readable by a computer, said computer program, when executed by the computer, causes the computer to perform operations for an access point that comprises a communication control device configured to connect one or more first terminals on a first network to the second network different from the first network, said operations comprising: connecting the one or more first terminals to the second network; and deactivating at least a part of the communication control device when a condition on a time length or a time is fulfilled, such that at least one target terminal of the one or more first terminals is disconnected from the second network.

### BRIEF DESCRIPTION OF THE DRAWINGS

FIG. 1 is a perspective view of an access point according to a first embodiment of the present invention;

FIG. 2 is a block diagram schematically showing a hardware configuration of the access point shown in FIG. 1 and peripheral devices connected thereto;

FIG. 3 is a schematic block diagram schematically showing a hardware configuration of a computer of a computer/MAC unit shown in FIG. 2;

FIG. 4 is a flowchart schematically showing operations executed by a first program stored in a memory shown in FIG. 3;

FIG. 5 is a flowchart schematically showing operations executed by a second program stored in the memory shown in FIG. 3;

FIG. 6 is a flowchart schematically showing operations executed by a third program stored in the memory shown in FIG. 3;

FIGS. 7A to 7C are front views of a display unit shown in FIG. 1 for illustrating an example of information displayed on a screen of the display unit;

FIGS. 8A to 8D are front views of the display unit for illustrating another example of information displayed on the screen of the display unit;

FIG. 9 is a block diagram schematically showing a hardware configuration of an access point according to a second embodiment of the present invention and peripheral devices connected thereto;

FIG. 10 is a block diagram schematically showing a hardware configuration of an access point according to a third embodiment of the present invention peripheral devices connected thereto;

FIG. 11 is a block diagram schematically showing a hardware configuration of a computer of a computer/MAC unit in an access point according to the fourth embodiment of the present invention;

FIG. 12 is a flowchart schematically showing a communication allowable time range setting routine executed by one or more programs shown in FIG. 11;

FIG. 13 is a flowchart schematically showing a time-up determination routine executed by the one or more programs shown in FIG. 11; and

FIG. 14 is a flowchart schematically showing a start time determination routine executed by the one or more programs shown in FIG. 11.

### DESCRIPTION

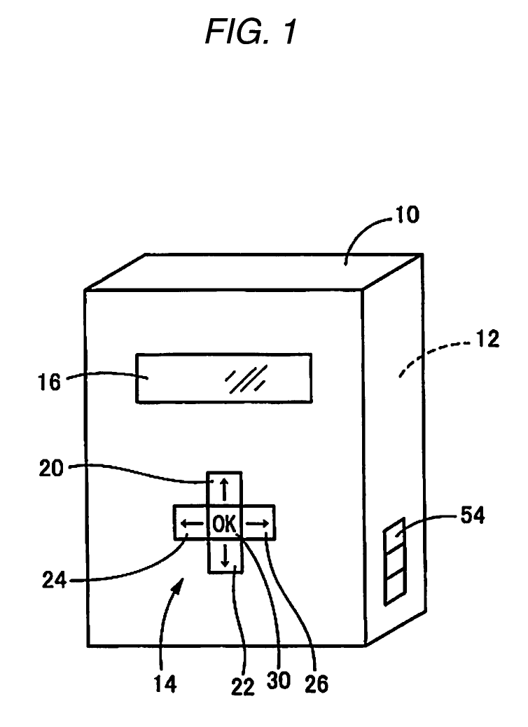

FIG. 1 shows a perspective view of an access point (hereinafter also referred to as an “AP”) 10 according to a first embodiment of the present invention.

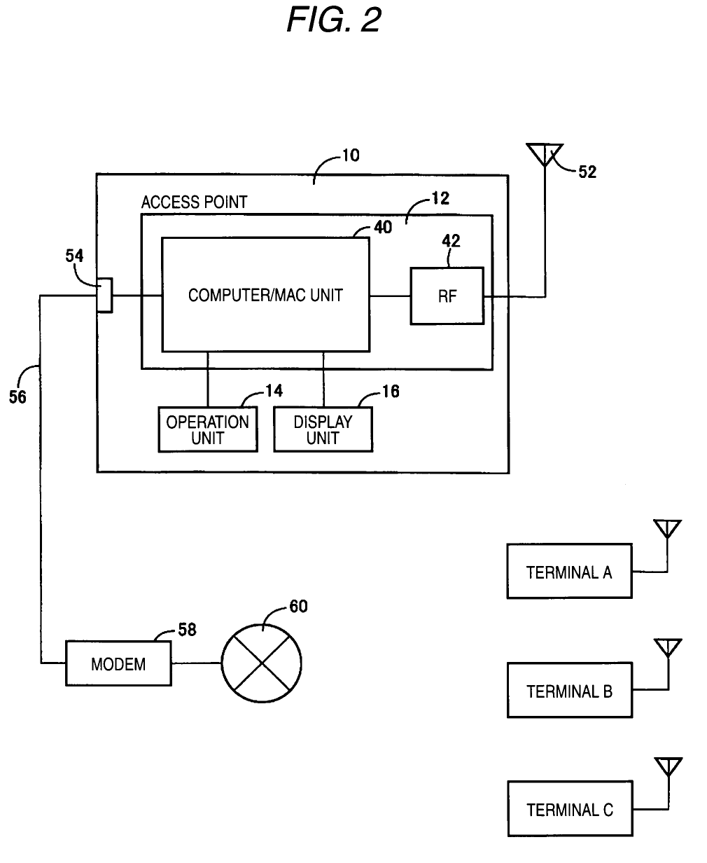

The AP 10 includes an electronic circuit unit (see FIG. 2) 12, an operation unit 14, and a display unit 16. The operation unit 14 includes four cursor keys (an up key 20, a down key 22, a left key 24, and a right key 26) and an “OK” key 30. The cursor keys are respectively associated with four directions, and pressing the cursor keys moves in the respective directions on a screen of the display unit 16. The “OK” key 30 selects an item displayed at a position indicated by the cursor on the screen of the display unit 16. The display unit 16 includes, for example, a Liquid Crystal Display (LCD).

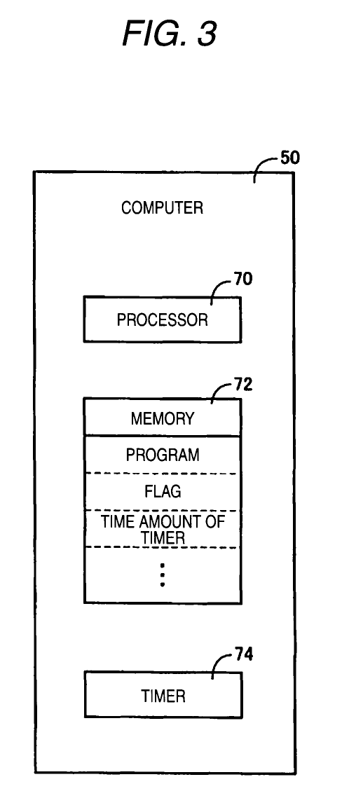

FIG. 2 is a schematic block diagram of the AP 10. The AP 10 includes a computer/MAC unit (hereinafter also referred to as a “CPU/MAC”) 40 and a radio frequency transceiver unit (hereinafter also referred to as an “RF”) 42. The computer/MAC unit 40 includes a computer 50 shown in FIG. 3 and a Media Access Control (MAC). The MAC includes a wireless control unit configured to control a wireless communication and a wired control unit configured to control a wired communication.

As shown in FIG. 2, both the computer/MAC unit 40 and the RF 42 are mounted to the electronic circuit unit 12. The RF 42 is equipped with an antenna 52 configured to transmit and receive a radio wave. The computer/MAC unit 40 is connected to the operation unit 14, the display unit 16, the RF 42, and a WAN port 54.

FIG. 2 also shows an environment in which the AP 10 is used. The AP 10 can wirelessly communicate with a terminal A (e.g., a game machine manufactured by Company X), a terminal B (e.g., a game machine manufactured by Company Y), and a terminal C (e.g., a PC having a wireless communication feature). The AP 10 constitutes, together with the terminals A to C, a wireless home network which serves as an example LAN.

The AP 10 is also connected to the Internet 60 serving as an example WAN via an Ethernet (registered trademark) cable 56 and a modem 58. One end of the Ethernet (registered trademark) cable 56 is connected to the WAN port 54, and the other end thereof is connected to the modem 58.

In other words, the AP 10 is connectable to two different networks (LAN and Internet via Ethernet). In the LAN, the AP 10 is a master node of the terminals A-C, and the terminals A-C are stations (slave nodes) of the AP 10. The AP 10 (more specifically, the RF 42, the computer/MAC unit 40 and the WAN port 54) allows the terminals A-C on the LAN to communicate with a terminal via the Internet 60. In other words, the AP 10 can connect the stations thereof on the LAN to an external node via the WAN.

FIG. 3 is a schematic block diagram of a computer 50 included in the computer/MAC unit 40. The computer 50 includes a processor 70, memory 72, and a timer 74 configured to count down from a set amount of time. These elements are interconnected by means of a bus.

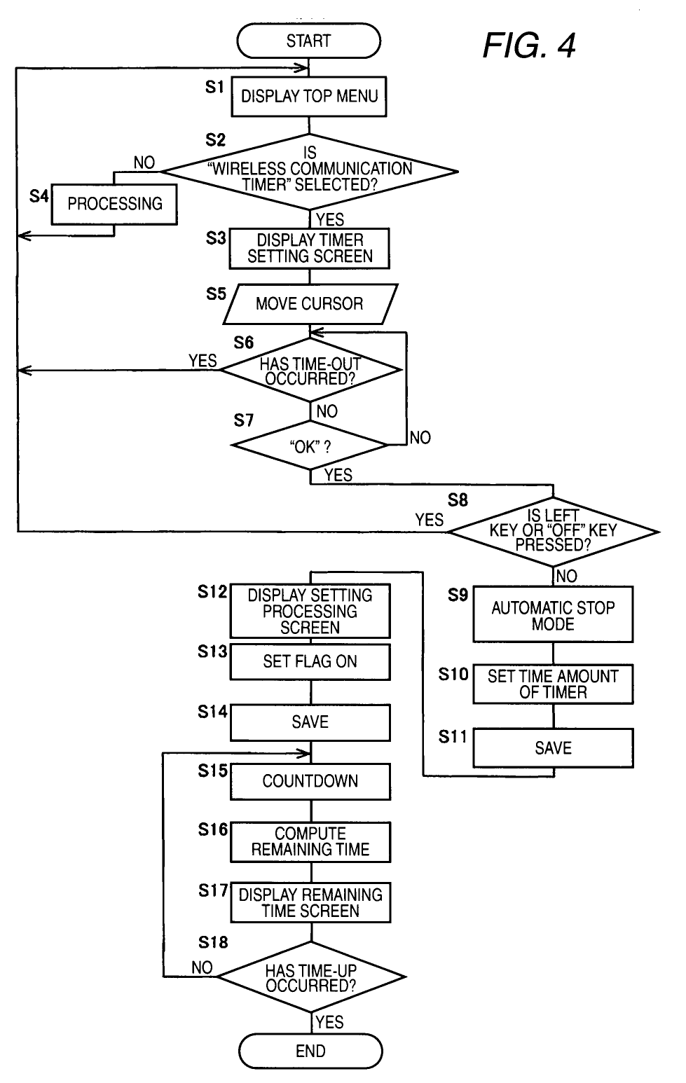

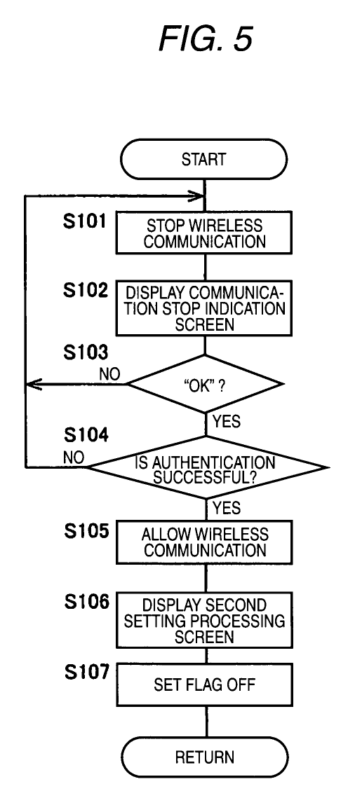

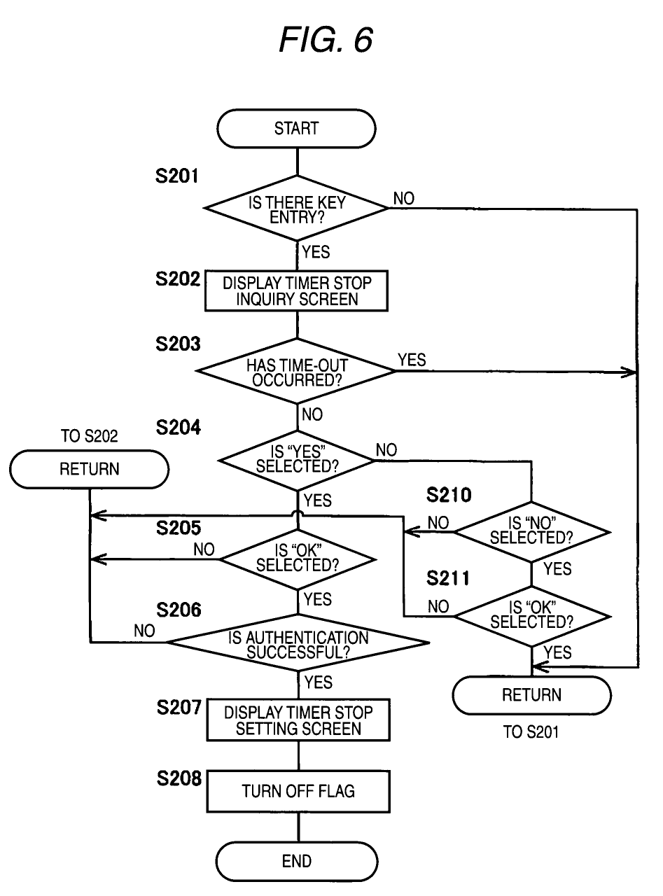

As shown in FIG. 3, a plurality of kinds of programs are stored in the memory 72. An example of the memory 72 includes a nonvolatile memory capable of retaining data even after the power is off. The programs may be previously stored in the memory 72. The programs include a first program, a second program, and a third program whose operations when executed are shown in flowcharts of FIG. 4, FIG. 5, and FIG. 6, respectively. The memory 72 can further store flags and also store a value of the previously-counted time.

The first to third programs enables the AP 10 to operate in an automatic stop mode selectively set to the AP 10. In the automatic stop mode, an access from the terminals A-C on the LAN to the Internet 60 is limited during an allowable time period. Specifically, the AP 10 is configured to disconnect the terminals A-C from the Internet 60 in response to an end of the allowable time period.

The AP 10 can disconnect the terminals A-C from the Internet 60 by deactivating (disabling the communication through) at least one of the RF 42, the MAC of computer/MAC unit 40 and the WAN port 54. As an example for disabling the RF 42, the power of RF 42 is turned off. In the following description of the first to fourth embodiments, an exemplified method for this disconnection is deactivating the MAC or RF 42 which stops the communication between the AP 10 and the terminals serving as stations of the AP 10.

The first program shown in FIG. 4 is repeatedly, continuously executed by the computer 50 during a period in which the AP 10 remains at power-on. In response to a start executing the first program, in S1, a TOP menu is displayed on the screen of the display unit 16. The TOP menu includes an item “timer for wireless communication” and other items.

When the item “timer for wireless communication” is selected by the user, wireless communication between the AP 10 and the terminals A-C is automatically stopped after elapse of a set time, regardless of the intentions of the users of the terminals A-C. Consequently, all of the users are automatically prohibited from accessing the Internet 60. Specifically, the item “timer for wireless communication” is an item selected by the user for selecting an automatic wireless communication stop mode.

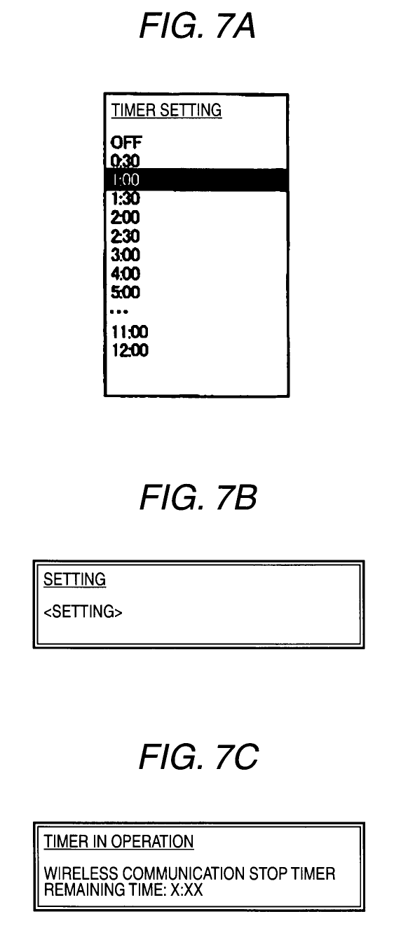

In step S2, it is determined whether the user has selected the item “timer for wireless communication.” If the user has selected the item “timer for wireless communication” (step S2: YES), the process proceeds to step S3. In step S3, as shown in FIG. 7A, a timer setting screen (data for use in designating and setting an amount of the time of a timer for the automatic wireless communication stop mode) is displayed on the screen of the display unit 16. The designated and set amount of time of the timer is to be counted by the timer 74. When a timer value reaches zero as a result of the countdown of the timer from the set amount of time, wireless communication is stopped.

In contrast, if the item “timer for wireless communication” has not been selected and that another item has been selected (step S2: NO), another processing conforming to a selected item is performed in step S4, and thereafter the processing returns to step S1.

Step S3 will now be described in detail.

When step S3 is executed, the timer setting screen is displayed on the display unit 16 as shown in FIG. 7A. In the timer setting screen, a plurality of selectable items appear on the screen of the display unit 16. The selectable items include: an item “OFF” selected for commanding nonselection of the automatic wireless communication stop mode; and a plurality of candidate time amounts of a timer for the automatic wireless communication stop mode.

For example, the time amount can be selectable from 30 minutes to 12 hours according to the candidate time amount. The candidate time amounts between 30 minutes and 3 hours are set at intervals of 30 minutes, and the candidate time amounts between 3 hours and 12 hours are set at intervals of one hour. An item of the selectable items which is currently selected by the cursor is highlighted. At the start of each operation of step S3, a time amount of the selectable items which is selected by the user during the previous operation (stored in the memory 72) is first displayed to be highlighted as defaults.

The cursor is moved in step S5 over the screen of the display unit 16 in accordance with the key operation performed by the user. Specifically, the cursor is cyclically moved among the selectable items in conformity with the direction of cursor movement assigned to corresponding one of the up key 20 and the down key 22 selected by the user. For example, when the up key 20 is operated with the cursor situated at the “OFF,” the cursor moves to “12:00.”

In the present embodiment, if the “OK” key 30 is operated while the left key 24 remains selected or the cursor remains situated at the “OFF,” processing returns to step S1 without proceeding to the automatic wireless communication stop mode. In contrast, if the “OK” key 30 is operated while any of the candidate time amount is selected by the cursor, processing proceeds to the automatic wireless communication stop mode, and then the candidate time amount selected by the cursor is designated as a set value of the time amount set to the timer in the current execution of the first program. The set amount of time of the timer is updated to the set value in the memory 72.

Specifically, in step S6, it is determined whether the time elapsed from immediately before performance of step S2 has reached a maximum allowable time period, that is, whether the timeout has expired. If the timeout has expired (S6: YES) the processing immediately returns to step S1.

In contrast, if the time elapsed from immediately before performance of step S2 has not reached the maximum allowable time period (timeout has not been expired) (step S6: NO), and processing proceeds to step S7. In step S7, it is determined whether the user has operated the “OK” key 30. If the “OK” key 30 is not operated (step S7: NO), and processing returns to step S6. In contrast, if the “OK” key 30 is operated (step S7: YES), and processing proceeds to step S8.

In step 8, it is determined whether, when “YES” at the step S7 is determined, the left key 24 is operated or the item “OFF” is selected. More specifically, it is determined whether there is fulfilled the condition that the user operates the left key 24 when YES is taken as a determination in step S7 or the condition that the “OFF” is selected by the cursor when YES is taken as a determination in step S7. When either of the two conditions is fulfilled, processing immediately returns to step S1. However, none of the conditions is fulfilled, processing proceeds to step S9.

In step S9, the operation mode of the AP 10 enters the automatic wireless communication stop mode. Subsequently, in step S10, one of the plurality of candidate time amounts currently selected by the cursor is set as a set value of the time amount of the timer. In step S11, the time amount of the timer set as the set value is saved in the memory 72.

In step S12, as shown in FIG. 7B, a setting processing screen is displayed on the screen of the display unit 16. The setting processing screen includes a message or graphic indicating that setting of the time amount of the timer is in progress. Subsequently, in step S13, the flag shown in FIG. 3 is set to ON. The flag set to ON shows that the automatic wireless communication stop mode is selected, whilst the flag set to OFF shows that the automatic wireless communication stop mode is not selected. In step S14, the flag is saved in the memory 72.

Operation of the timer 74 is commenced in step S15 so that the timer 74 counts down from the time amount set as the set value. Subsequently, the current the timer value, that is, a remaining time until the set amount of time of the timer is up, is computed in step S16.

In step S17, as shown in FIG. 7C, a remaining time screen, which indicates the remaining time, is displayed on the screen of the display unit 16. In step S18, it is determined whether the remaining time has come to zero, that is, whether the set amount of time of the timer is up. If time is not yet up (step S18: NO), processing returns to step S15. In contrast, if the set amount of time of the timer is up (step S18: YES), single execution of a first program is completed.

Steps S15 through S18 form a loop to be repeatedly executed. However, the operation of the third program is interrupted during the execution of the loop.

If it is determined that the set amount of time of the timer is up in step S18 (step S18: YES), execution of the second program is initiated.

In response to a start of execution of the second program, in step S101 shown in FIG. 5, a signal for stopping wireless communication with all of the terminals A through C is first supplied to the MAC. The MAC does not stop communication between the AP 10 and a terminal connected via the Internet 60.

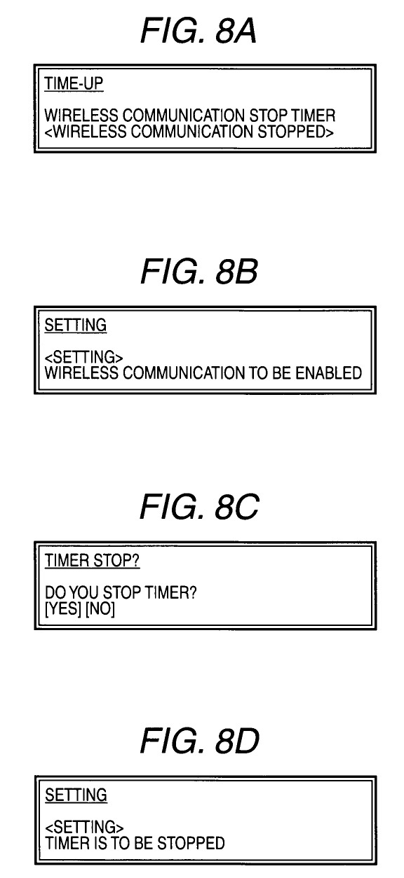

In step S102, as shown in FIG. 8A, a communication stop indication screen is displayed on the screen of the display unit 16. The communication stop indication screen includes a message or graphic indicating that wireless communication is in a stopped state.

In step S103, it is determined whether the “OK” key 30 is operated by the user in order to command the AP 10 to resume wireless communication. If the “OK” key 30 is not operated (step S103: NO), processing proceeds to step S101 without resumption of wireless communication.

In contrast, if the “OK” key 30 is operated (step S103: YES), it is determined in step S104 whether a password input by the user is valid, whereby the user is verified. If authentication of the user ends in failure (step S104: NO), processing returns to step S101 without resumption of wireless communication.

In contrast, if authentication of the user is successful (step S104: YES), a signal for enabling wireless communication is supplied to the MAC in step S105. As a result, the automatic wireless communication stop mode is cancelled. In step S106, a second setting processing screen shown in FIG. 8B is displayed on the screen of the display unit 16. The second setting processing screen includes a message or graphic indicating that a setting for enabling wireless communication is in progress.

In step S107, the flag is set to off, whereby cancellation of the automatic wireless communication stop mode is saved in the memory 72.

Current execution of the second program is thus completed, and next execution of processing is started from step S101. Before performing next execution of the second program, the computer 50 resumes execution of the first program shown in FIG. 4 from step S1.

When processing of an interrupt of the third program shown in FIG. 6 is performed, in step S201, it is determined whether one of the four cursor keys 20, 22, 24, and 26 and the “OK” key 30 has been operated during the course of the timer 74 counting down the time of the timer. The user can operate the cursor keys 20, 22, 24 and 26 and the “OK” key 30 for command the AP 10 to cancel the automatic stop mode. Further, in step S201, it is determined which one of the cursor keys 20, 22, 24 and 26 the “OK” key 30 has been operated. When none of the keys 20, 22, 24, 26, and 30 has been operated during the countdown operation, processing of an interrupt of the third program is immediately completed. Processing of the next interrupt of the third program is initiated from step S201.

In contrast, if any of the keys 20, 22, 24, 26, and 30 is operated during the course of a countdown, the user is asked (step S201: YES), the processing proceeds to step S202. In step S202, a timer stop inquiry screen shown in FIG. 8C is displayed on the screen of the display unit 16. The timer stop inquiry screen includes information for inquiring the user whether the user desires to stop a countdown performed by the timer 74; i.e., whether the user desires to cancel the automatic wireless communication stop mode. Specifically, “YES” and “NO” are displayed on the screen of the display unit 16 as two types of answers to be chosen by the user.

Subsequently, in step S203, it is determined whether the time elapsed since the determination rendered in step S201 finally became YES has exceeded a threshold time-out period; namely, whether a time-out occurs. An example of the threshold time-out period is 120 seconds, but it is not limited thereto. When the time-out occurs, processing of an interrupt of the third program is immediately completed. Processing of the next interrupt of the third program is initiated from step S201.

In contrast, if the time-out has not yet occurred (step S203: YES), it is determined in step S204 whether the user has selected “YES.” When “YES” is not selected (step S204: NO), it is determined in step S210 whether the user has selected “NO.” If “NO” is selected (S210: YES), it is determined in step S211 whether the “OK” key 30 is operated by the user. If the “OK” key 30 is operated (S211: YES), processing of an interrupt of the third program is immediately completed. Processing of the next interrupt of the third program is initiated from step S201.

In S211, if the “OK” key 30 is not operated (step S211: NO), processing of the interrupt of the third program is immediately completed as in the case where the “OK” key 30 is operated. However, in this case, processing of the next interrupt of the third program is initiated from step S202.

In contrast, in S204, if “YES” is selected (step S204: YES), it is determined in step S205 whether the user has operated the “OK” key 30. If the “OK” key 30 is not operated (step S205: NO), processing of the interrupt of the third program is immediately completed. Processing of the next interrupt of the third program is initiated from step S202.

If the “OK” key 30 is operated (step S205: YES), an user authentication is performed. Specifically, it is determined in step S206 whether the password input by the user is valid. If the input password is invalid, that is, authentication of the user ended in failure (step S206: NO), processing of the interrupt of the third program is immediately completed without canceling the automatic wireless communication stop mode. Processing of the next interrupt of the third program is initiated from step S202.

If the input password is valid, that is, authentication of the user is successful (step S206: YES), a timer stop setting screen shown in FIG. 8D is displayed on the screen of the display unit 16. The timer stop setting screen includes a message or graphic indicating that the automatic wireless communication stop mode is canceled.

Subsequently, the flag is set to off in step S208, whereby cancellation of the automatic wireless communication stop mode is stored in the memory 72.

Current processing of the third program is thus stopped, and the program is next executed from step S201. Before executing the third program next time, the computer 50 resumes performance of the first program shown in FIG. 4 from step S1.

In the present embodiment, the AP 10 communicates with the terminals A-C via the RF 42, and when the specified allowable time period expires during the automatic stop mode being active, the RF 42 is deactivated. As a result, all the terminals A-C are disconnected from the Internet 60. In other words, all of the terminals A-C correspond to target terminals as a target for managing (limiting) a time period for a connection with the Internet 60.

The AP 10 may notify at least one of the users of the target terminals (in this embodiment, the terminals A-C) before a stop of wireless communication that wireless communication will be stopped by settings of the AP 10 when the time of the timer is up. Specifically, the computer 50 may issue a notification indicating a stop of the communication when the target terminal is disconnected from the second network. The notification can include display and/or audio information output through a display/speaker device such that the user can visually/audibly recognize the notification.

In addition, in the present embodiment, the operation unit 14 is attached to the AP 10, and the user can perform an input operation for the AP 10 via the operation unit 14. However, when the AP 10 is connected to; for instance, a PC, the user can perform an input operation for the AP 10 via an operation unit of the PC. In other words, an input device for the AP 10 may be integrated with the AP 10 or may be separated from the AP 10. The input device may be used for the setting of the automatic stop mode, such as a designation of the time period for allowing the connection from the terminals A-C with the Internet 60.

Next, a second embodiment of the present invention will be described. The common elements between the first embodiment and the second embodiment are cited by use of the same reference symbols, thereby omitting their overlapping explanations.

In the first embodiment, the AP 10 wirelessly communicates with its stations via a single wireless LAN standard. In the present embodiment, the AP 10 has wireless communication functions of a plurality types of wireless LAN standards. In the illustrated embodiment, there are two types of wireless LAN standards which include IEEE (Institute of Electrical and Electronics Engineers) 802.11a and 802.11b/g.

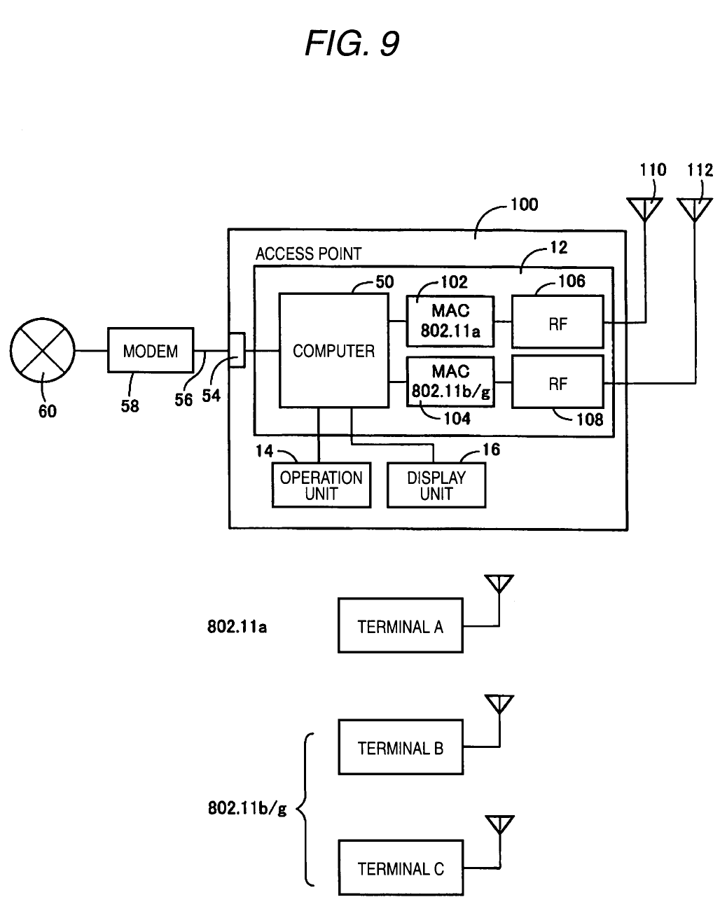

FIG. 9 shows a schematic block diagram of an AP 100 according to the second embodiment.

The AP 100 includes: an electronic circuit unit 12. The electronic circuit unit 12 includes two types of MACs 102 and 104; two types of RFs 106 and 108 corresponding to the MACs 102 and 104, respectively; and the computer 50 common between the MACs. The electronic circuit unit 12 can also establish wired communication with the Internet 60 via another MAC.

The AP 100 further includes two types of antennas 110 and 112 connected respectively to the RFs 106 and 108.

In the present embodiment, the terminal A supports only with IEEE802.11a, and both the terminals B and C support only with IEEE802.11b/g.

In one example of the present embodiment, the computer 50 can control the two types of MACs 102 and 104 such that wireless communication established between the AP 100 and all of the terminals A through C is stopped when the set amount of time of the timer is up. In this case, all of the terminals A through C correspond to target terminals as a target for managing (limiting) a time period of a connection with the Internet 60.

In contrast, in another example of the present embodiment, the computer 50 can control the two types of MACs 102 and 104 such that, when the set amount of time of the timer is up, only wireless communication established between the AP 100 and the terminal A is stopped and that wireless communication established between the terminals B and C still remain available. In this case, only the terminal A corresponds to the target terminal as a target for managing (limiting) a time period of a connection with the Internet 60 is managed.

In still another example of the present embodiment, the computer 50 can control the two types of MACs 102 and 104 such that, when the set amount of time of the timer is up, only wireless communication established between the AP 100 and the terminals B and C is stopped and that wireless communication with the terminal A still remains available. In this case, the terminals B and C correspond to the target terminal as a target for managing (limiting) a time period of a connection with the Internet 60.

A third embodiment of the present invention will be described. The common elements between the first embodiment and the third embodiment are cited by the same reference symbols, thereby omitting their overlapping explanations.

In the first embodiment, the AP 10 includes only one wired port, WAN port 54. In contrast, in the present embodiment, the AP 10 further includes a plurality of wired ports. Specifically, in the embodiment, the AP 10 includes a plurality of wired LAN ports in addition to the one WAN port 54.

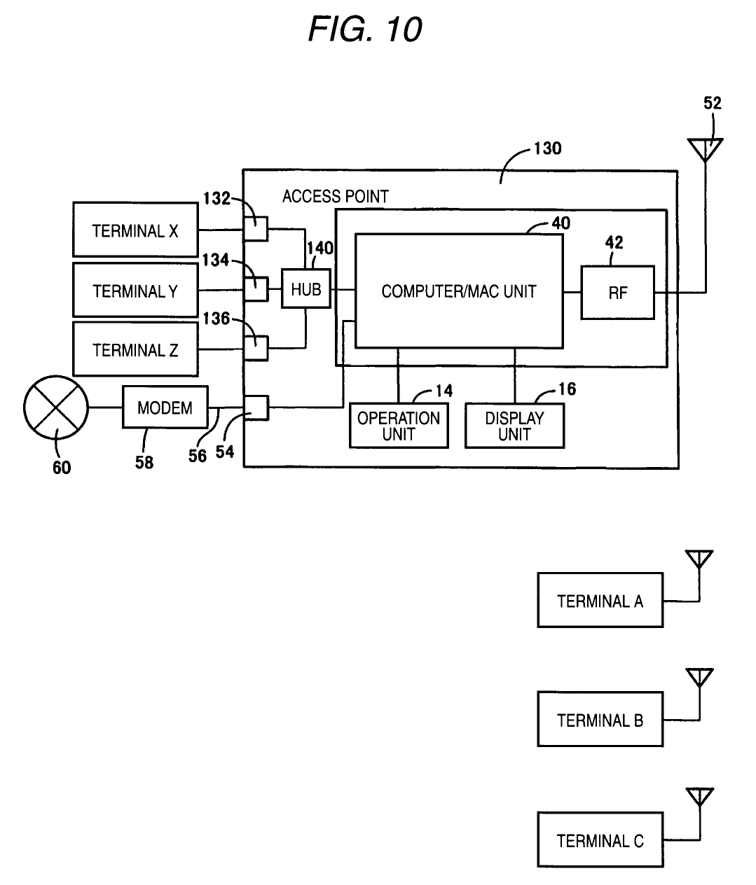

FIG. 10 shows a schematic bloc diagram of an AP 130 according to the third embodiment of the present invention.

As shown in FIG. 10, the AP 130 includes a plurality of LAN ports 132, 134, and 136 to allow wired connections for terminals. In the illustrated embodiment, terminals X through Z are connected to the LAN ports 132, 134, and 136 via LAN cables. Accordingly, the AP 130 constitutes, together with the terminals X through Z, a wired LAN.

The AP 130 further includes a hub 140 for tying the LAN ports 132, 134, and 136 together and connected to the computer/MAC unit 40.

In an example of the present embodiment, when the set amount of time of the timer is up, the computer/MAC unit 40 operates such that wireless communication established between the AP 130 and all of the terminals A through C is stopped, and that wired communication established among all of the terminals X through Z remain continually available. In this case, all of the terminals A through C correspond to target terminals as a target for managing (limiting) a time period for a connection with the Internet 60.

In another example of the present embodiment, when the set amount of time of the timer is up, the computer/MAC unit 40 operates such that wired communication established between the AP 130 and some of the terminals X through Z (e.g., the terminal X) is stopped and that wired communication established between the AP 130 and the remaining terminals X through Z (e.g., the terminals Y and Z) and wireless communication established between the AP 130 and the terminals A through C remain continually available. In this case, the some of the terminals X through Z (e.g., the terminal X) correspond to the target terminals as a target for managing (limiting) a time period for a connection with the Internet 60.

A fourth embodiment of the present invention will now be described.

In the first embodiment, when the set amount of time of the timer elapses since the timer 74 has been started, the terminals A through C become unable to connect to the Internet 60 via the AP 10. In contrast, in the present embodiment, a communication allowable time range is set by the user. Specifically, when an end time of the communication allowable time range comes, the terminals A through C become unable to connect to the (i.e., disconnected from) Internet 60 via the AP 10.

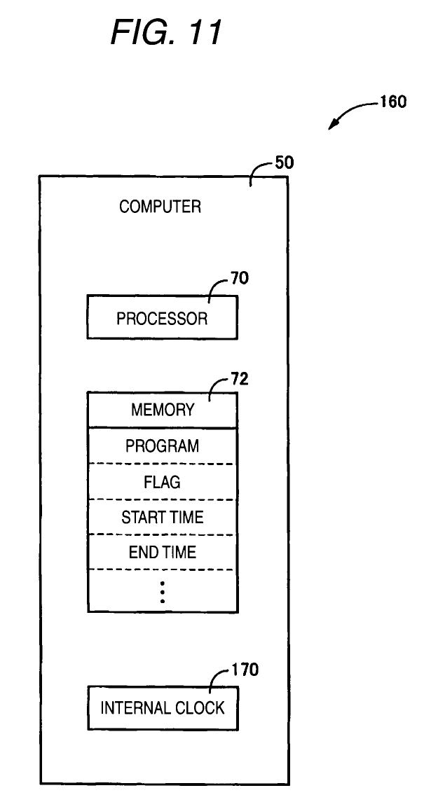

FIG. 11 shows a schematic bloc diagram of the computer 50 in an AP 160 according to the present embodiment.

The AP 160 of this embodiment includes an internal clock 170 instead of the timer 74 of the first embodiment. The internal clock 170 is configured to reflect time information (information about a standard time) received from an external time server via the Internet 60 through use of an NTP (Network Time Protocol).

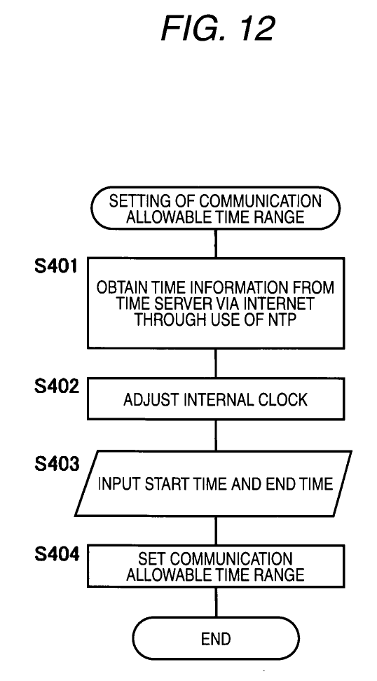

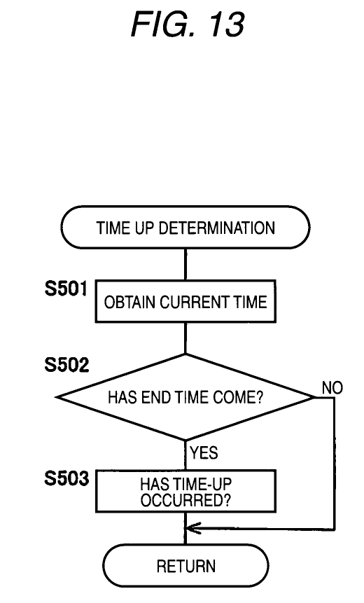

The computer 50 can perform processings relating to the automatic wireless communication stop mode, by executing first through third programs which are partially common to the operations of first through third programs shown in FIGS. 4 through 6. FIGS. 12 and 13 show steps of the first program of the present embodiment that differ from the steps in connection with the first embodiment.

FIG. 12 shows a flowchart schematically explaining the operation by the first program, which serves as a substitute for step S10 in the first embodiment. This flowchart shows a communication allowable time range setting routine.

When the communication allowable time range setting routine is executed, time information received from the external time server via the Internet 60 is first received in step S401 by use of the NTP. In step S402, the internal clock 170 is adjusted such that the received time information is reflected. Namely, time synchronization is performed.

Subsequently, in step S403, the user enters a start time and an end time of the communication allowable time range to be set. The input start time and end time are stored in the memory 72. In step S404, the communication allowable time range is set based on the input start time and end time. Thus, the communication allowable time range setting routine is completed.

FIG. 13 shows a flowchart schematically explaining the operation by the first program as a time-up determination routine, which serves as substitutes for steps S15 through S18 in the first embodiment.

When the time-up determination routine is performed, a current time is obtained from the internal clock 170 in step S501. Next, in step S502, the end time is read from the memory 72, and it is determined whether the end time read from the memory 72 coincides with the current time. In other words, it is determined whether the end time has come.

If the end time has not yet come (step S502: NO), single performance of the time-up determination routine is immediately completed. In contrast, if the end time has come (step S502: YES), the process proceeds to step S503, and it is determined that the communication allowable time range has passed thereby the time has been up. Thus, single performance of the time-up determination routine is completed.

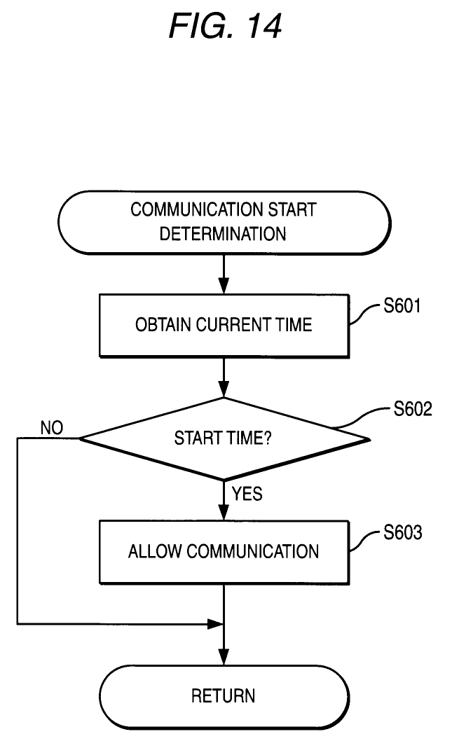

Next, the communication start determination subroutine is described with reference to FIG. 14. In this subroutine, if the start time that has been received and set comes, the AP starts to allow a connection from terminal(s) as slave node(s) to the Internet 60.

The communication start determination subroutine is executed after step 14 shown in FIG. 4 but before the time-up determination subroutine shown in FIG. 13.

When the communication start determination subroutine starts, a current time is obtained from the internal clock 170 in step S601. Next, in step S602, the start time is read from the memory 72, and it is determined whether the start time read from the memory 72 coincides with the current time. In other words, it is determined whether the start time has come.

If the start time has not yet come (step S602: NO), single performance of the communication start determination routine is immediately completed. In contrast, if the start time has come (step S602: YES), the process proceeds to step S603, and it is determined that the communication allowable time range has entered, thereby a connection between the target terminals the Internet 60 is allowed. Then, single performance of the communication start determination routine is completed.

The communication allowable time range may be selectively set such that the setting of the communication allowable time range is cleared when the end time has passed or is maintained even after the end time has passed. When the communication allowable time range is set to be maintained even after the end time, the days for the set communication allowable time range available can be specified, for example, every day, every specified day of week, etc.

The above-described embodiments of the invention provides the following illustrative aspects.

(1) An access point connectable to a first network and a second network different from the first network, said access point comprises: a communication control device configured to connect one or more first terminals on the first network to the second network; and a communication stop device configured to deactivate at least a part of the communication control device when a condition on a time length or a time is fulfilled, such that at least one target terminal of the one or more first terminals is disconnected from the second network.

(2) In the access point of the above-described item (1), the communication control device may be configured to communicate with the first terminal that is a slave node of said access point so as to allow the first terminal to communicate with a second terminal that is a non-slave node of said access point via the second network.

(3) In the access point of the above-described item (1) or (2), the communication stop device may stop communication between the communication control device and the target terminal when the condition is fulfilled.

According to the access point, when the condition on the time length or the time are fulfilled, the target terminal on the first network, which may be all or a part of the one or more first terminal, is automatically disconnected from the second network.

Therefore, in the access point, when, for instance, a threshold time period elapsed, the target terminal becomes unable to access to the second network. For example, the target terminal can not communicate with the second terminal (a non-slave (external) node of the access point) via the second network. Further, if there is a terminal on the first network (e.g., a slave node of the access point) other than the target terminal, the target terminal may become unable to make an access to the terminal.

Consequently, the access point can limit the access from the target terminal to the second network (e.g., access to another terminal via the second network) within a threshold time period.

The terminal may be, for example, a personal computer or an electronic device equipped with a computer (e.g., a game machine).

An example of the first network may include a LAN, and an example of the second network may include a WAN such as the Internet.

The first network may be a group of the access point and one or more slave nodes of the access point, such as: a wireless LAN shown in FIGS. 2 and 9; and the wired LAN and the wireless LAN shown in FIG. 10. In this case, the first terminal is a slave node of the access point.

An example of the communication control device may include: at least one of the WAN port 54, the MAC of the computer/MAC unit 40 and the RF 42 shown in FIGS. 2 and 10; at least one of the WAN port 54, the MAC 102 and MAC 104, and RFs 106 and 108 shown in FIG. 9.

An example of the communication stop device may include the computer 50 executing the first through third programs shown in FIGS. 4 through 6 and FIGS. 12 and 13.

An example of the condition on time length or time may include a time period allowing the connection from the target terminal to the second network, such as a time period defined by a specified amount of time, a time period defined by a time range including a specified end time, or a time period defined by a time range between specified start and end times.

(4) In the access point of the above-described item (3), the communication control device may comprise: a communication unit configured to communicate with the target terminal; and an access control unit configured to control communication through the communication unit, wherein the communication stop device deactivates the communication unit when the condition is fulfilled.

Accordingly, the access point can limit the access from the target terminal to the second network by deactivating the communication unit. An example of the communication unit may include a communication device such as: the RF 42 shown in FIGS. 2 and 10; and the RF 106 and RF 108. An example of the access control unit may include a MAC of the computer/MAC unit 40 shown in FIGS. 2 and 10, or the MACs 102 and 104.

(5) In the access point of any of the items (1) to (4), even when the condition is fulfilled, the communication stop device maintains a connection between the one or more first terminals except the target terminal and the second network.

In the access point, the access point allows a remainder of the one or more first terminal except the target terminal to continually access to the second network regardless of whether the condition for disconnecting the target terminal from the second network is fulfilled.

(6) In the access point of any of the items (1) to (5), the communication stop device may comprise: a condition setting unit configured to receive a designation of the condition and set the condition; a determination unit configured to determine whether the condition set by the condition setting unit is fulfilled; and a communication stop unit configured to disconnect the target terminal and the second network when the determination unit determines that the condition is fulfilled.

Accordingly, the access from the target terminal to the second network can be limited by the condition set by the condition setting unit. An example of the condition setting unit may include the computer 50 executing the steps S3 to S11 shown in FIG. 4, an example of the determination unit may include the timer 74 and the computer executing the steps S14 t S19 shown in FIG. 4, and an example of the communication stop unit may include the computer 50 executing the step S101 shown in FIG. 5.

(7) In the access point of the item (6), the condition setting unit may allow the designation of the condition to comprise an amount of time for which the target terminal is allowed to be connected to the second network; the communication stop device may further include a timer; the determination unit may determine whether the allowable amount of time has elapsed with reference to the timer; and the communication stop unit may deactivate at least a part of the communication control device when the allowable time period has elapsed.

In this access point, the condition is fulfilled as a result of passage of the allowable amount of time set by the user. When the communication allowable time set by the user elapsed, the target terminal becomes unable to connect to the second network. Therefore, the user of the target terminal is limited in terms of the length of the time during which the network is available.

(8) In the access point of the item (6) or (7), the condition setting unit may allow the designation of the condition to comprise an end time of an allowable time range during which the target terminal is allowed to be connected to the second network; the communication stop device may further include an internal clock; the determination unit may determine whether the end time of the communication allowable time range has reached with reference to the internal clock; and the communication stop unit may deactivate at least a part of the communication control device when a time indicated by the internal clock reaches the end time of the communication allowable time range.

In the access point, the condition is fulfilled as a result of the end time of the communication allowable time range set by the user has come. When the end time of the communication allowable time set by the user comes, the target terminal becomes unable to connect to the second network. Therefore, the user of the target terminal is limited in terms of a time period during which a network is available.

(9) In the access point of any of items (1) to (8) the communication stop device may further include a notification unit configured to issue a notification indicating a stop of the communication when the target terminal is disconnected from the second network.

In the access point, when the access point disconnects the target terminal from the second network, the user of the target terminal can ascertain that a stop of communication is not an incidental event but a scheduled event. Therefore, the access point enables the user of the target terminal to immediately recognize a cause for a stop of communication, and the user hence does not need to feel anxiety for a long period of time.

(10) The access point of any of items (1) to (9) may further include a mode setting unit configured to selectively set an automatic stop mode in which the target terminal is automatically disconnected from the second network when the condition is fulfilled, and the communication stop device may further include a first authentication unit configured to perform an authentication to allow a cancel of the automatic stop mode before the target terminal is automatically disconnected from the second network.

Accordingly, the cancellation of the automatic stop mode can be limited to the authorized user, such as parents. Accordingly, the access limitation can be properly managed. An example of the mode setting unit may include the computer 50 executing steps S1 to S9 shown in FIG. 4, and an example of the first authentication unit may include the computer 50 executing step S206 shown in FIG. 6.

(11) In the access point of any of items (1) through (10), the communication stop device may further include a communication stop cancellation unit configured, during a disconnection between the target terminal and the second network, to cancel disconnection when a cancel condition allowing a cancellation of the disconnection is fulfilled.

Accordingly, the cancellation of the disconnection caused by automatic stop mode can be limited to the case where the cancellation condition is fulfilled. The access limitation can be properly managed. An example of the communication stop cancellation unit may include the computer 50 executing steps S103 and S105 shown in FIG. 5.

(12) In the access point defined in item (11), the communication stop device may further include a second authentication unit configured to perform an authentication to allow the communication stop cancellation unit to cancel the disconnection.

Accordingly, the cancellation of the disconnection caused by automatic stop mode can be limited to the authorized user, such as parents. In other words, the authorized user can reopen the connection of the target terminal to the second network. Accordingly, the access limitation can be properly managed. An example of the second authentication unit may include the computer 50 executing step S104 shown in FIG. 5.

(13) A method for operating an access point that comprises a communication control device configured to connect one or more first terminals on a first network to the second network different from the first network, said method comprises: connecting the one or more first terminals to the second network; and deactivating at least a part of the communication control device when a condition on a time length or a time is fulfilled, such that at least one target terminal of the one or more first terminals is disconnected from the second network.

When the method is implemented, on condition that the condition on the length of a time or a time are fulfilled, the target terminal, which may be all or a part of the one or more first terminals, is automatically disconnected from the second network. An example of the process of the connecting may include the operations executed by the computer/MAC unit 40, and the process of the deactivating may include operations of the computer 50 executing the first to third programs.

Therefore, according to the method, when, for instance, a threshold time period elapsed, the target terminal becomes unable to access to the second network. For example, the target terminal can not communicate with the second terminal (non-slave node of the access point) via the second network. Further, if there is a terminal on the first network (e.g., slave node of the access point) other than the target terminal, the target terminal may become unable to make an access to the terminal.

Consequently, according to the method, the access of the target terminal to the second network (e.g., access to another terminal via the second network) is limited within a threshold time period.

(14) A program enables a computer perform each operations of the method defined in the item (13).

The program of the item (13) may be a combination of commands executed by a computer to fulfill its function or may include files or data to be processed in accordance with respective commands. However, the program is not limited thereto.

The program may be solely executed by the computer or may be executed by a computer along with another program. However, the program is not limited thereto. In the latter case, the program of item (11) can be embodied as being formed of data, but it is not limited thereto.

(15) A computer readable medium having the program defined in the item (14) stored thereon and readable by a computer.

Various types of the computer readable media can be adopted. For instance, a magnetic recording medium such as a flexible disk; an optical recording medium such as a CD and CD-ROM; a magneto-optical recording medium such as an MO; an unremovable storage such as ROM; may also be adopted; however, the computer readable medium is not limited thereto.

What is claimed is:

1. An access point connectable to a first network and a second network different from the first network, said access point comprising:
a communication control device configured to connect one or more first terminals on the first network to the second network; and
a communication stop device configured to deactivate at least a part of the communication control device when a condition on a time length or a time is fulfilled, such that at least one target terminal of the one or more first terminals is disconnected from the second network.

2. The access point according to claim 1,
wherein the communication control device is configured to communicate with the first terminal that is a slave node of said access point so as to allow the first terminal to communicate with a second terminal that is a non-slave node of said access point via the second network.

3. The access point according to claim 1, wherein the communication stop device stops communication between the communication control device and the target terminal when the condition is fulfilled.

4. The access point according to claim 3,
wherein the communication control device comprises: a communication unit configured to communicate with the target terminal; and an access control unit configured to control communication through the communication unit, and
wherein the communication stop device deactivates the communication unit when the condition is fulfilled.

5. The access point according to claim 1, wherein, even when the condition is fulfilled, the communication stop device maintains a connection between the one or more first terminals except the target terminal and the second network.

6. The access point according to claim 1, wherein the communication stop device comprises:
a condition setting unit configured to receive a designation of the condition and set the condition according to the designation;
a determination unit configured to determine whether the condition set by the condition setting unit is fulfilled; and
a communication stop unit configured to disconnect the target terminal from the second network when the determination unit determines that the condition is fulfilled.

7. The access point according to claim 6,
wherein the condition setting unit allows the designation of the condition to comprise an amount of time for which the target terminal is allowed to be connected to the second network;
wherein the communication stop device further comprises a timer;
wherein the determination unit is configured to determine whether the allowable amount of time has elapsed with reference to the timer; and
wherein the communication stop unit deactivates at least a part of the communication control device when the allowable time period has elapsed.

8. The access point according to claim 6,
wherein the condition setting unit allows the designation of the condition to comprise an end time of an communication allowable time range during which the target terminal is allowed to be connected to the second network;
wherein the communication stop device further comprises an internal clock;
wherein the determination unit is configured to determine whether the end time of the communication allowable time range has reached with reference to the internal clock; and
wherein the communication stop unit deactivates at least a part of the communication control device when a time indicated by the internal clock reaches the end time of the communication allowable time range.

9. The access point according to claim 1, wherein the communication stop device comprises a notification unit configured to issue a notification indicating a stop of the communication when the target terminal is disconnected from the second network.

10. The access point according to claim 1, further comprising a mode setting unit configured to selectively set an automatic stop mode in which the target terminal is automatically disconnected from the second network when the condition is fulfilled,
wherein the communication stop device further comprises a first authentication unit configured to perform an authentication to allow a cancel of the automatic stop mode before the target terminal is automatically disconnected from the second network.

11. The access point according to claim 1, wherein the communication stop device further comprises a communication stop cancellation unit configured, during a disconnection between the target terminal and the second network, to cancel the disconnection when a cancel condition allowing a cancellation of the disconnection is fulfilled.

12. The access point according to claim 11, wherein the communication stop device further comprises a second authentication unit configured to perform an authentication to allow the communication stop cancellation unit to cancel the disconnection.

13. A method for operating an access point that comprises a communication control device configured to connect one or more first terminals on a first network to the second network different from the first network, said method comprising:
connecting the one or more first terminals to the second network; and
deactivating at least a part of the communication control device when a condition on a time length or a time is fulfilled, such that at least one target terminal of the one or more first terminals is disconnected from the second network.

14. A computer readable medium having a computer program stored thereon and readable by a computer, said computer program, when executed by the computer, causes the computer to perform operations for an access point that comprises a communication control device configured to connect one or more first terminals on a first network to the second network different from the first network, said operations comprising:
connecting the one or more first terminals to the second network; and
deactivating at least a part of the communication control device when a condition on a time length or a time is fulfilled, such that at least one target terminal of the one or more first terminals is disconnected from the second network.
